(19) United States
(12) Patent Application Publication
(10) Pub. No.: US 2023/0356359 A1
(43) Pub. Date: Nov. 9, 2023

(54) Blast Machine and Method for Operating a Blast Machine

(71) Applicant: DyeMansion GmbH, Planegg (DE)

(72) Inventors: Joscha Innecken, München (DE); Maximilian Spes, München (DE); Hansjörg Kauschke, Oberhaching (DE); Valentin Grabmaier, Neuried (DE); Philipp Kramer, München (DE); Julius Legenmajer, München (DE)

(21) Appl. No.: 18/042,784

(22) PCT Filed: Aug. 26, 2021
(86) PCT No.: PCT/EP2021/073595

§ 371 Date: Feb. 24, 2023

(30) Foreign Application Priority Data
Aug. 27, 2020 (DE) 10 2020 122 479.6

(51) Int. Cl. B24C 3/28; B33Y 40/20; B24C 9/00; B24C 7/00

(52) U.S. Cl. CPC B24C 3/28; B33Y 40/20; B24C 9/003; B24C 7/0046

(57) ABSTRACT

Various examples of the disclosure relate to a blast machine having a process chamber. A tumble belt, for example, can be arranged in the process chamber. Techniques for venting the process chamber are described. Techniques for fastening the tumble belt are described. Techniques for operating blasting nozzles are described.

### CROSS-REFERENCE TO RELATED APPLICATIONS

This application is the United States national phase of International Application No. PCT/EP2021/073595 filed Aug. 26, 2021, and claims priority to German Patent Application No. 2020 122 479.6 filed Aug. 27, 2020, the disclosures of which are hereby incorporated by reference in their entireties.

### BACKGROUND OF THE INVENTION

### Field of the Invention

Various examples of the invention relate generally to techniques for operating a blast machine and designs of the blast machine, in particular a process chamber of the blast machine.

### Description of Related Art

Blast machines are used to treat the surfaces of components. In this case, blasting material (sometimes also referred to as blasting medium) is blasted into a process chamber of the blast machine by means of a blasting nozzle, wherein the process components to be treated are located in the process chamber. The surface of the components is treated by the physical interaction of the particles of the blasting material with the surface of the components. For example, dirt or contaminants can be removed from the surface, porosity reduced, etc.

### SUMMARY OF THE INVENTION

There is a need for improved blast machines. In particular, there is a need for blast machines that require little maintenance, enable easy loading of process components, enable safe and efficient operation, and ensure easy interaction with the user.

This object is achieved by the features of the independent claims. The features of the dependent claims define embodiments.

A blast machine comprises a housing.

A process chamber can be formed in the housing.

The process chamber can optionally be front-loaded, for example. For example, a door could be attached to a front side of the process chamber, optionally a lifting door, which can be moved up or to the side, for example.

It is conceivable that the blast machine optionally has one or more fan modules. Each of the one or more fan modules can have one or more corresponding fans.

It would be conceivable that the blast machine optionally comprises at least one first fan, which is configured to extract substances from the process chamber using a first suction power and a first volume flow, and at least one second fan, which is configured to extract substances from the process chamber using a second suction power and a second volume flow.

Optionally, the first suction power can be greater than the second suction power. Alternatively or additionally, the first volume flow can be less than the second volume flow.

In some examples it would be conceivable that a tumble belt is arranged in the process chamber. This can form a trough. Process components can be arranged in the trough.

As a general rule, it would be conceivable for the tumble belt to be formed from multiple segments. These can, for example, be detachably connected to one another. The segments could also be plugged into one another.

Sometimes it can be possible that webs are applied to the tumble belt, which extend perpendicularly to a surface of the tumble belt. It would be conceivable that such webs are aligned, for example, along the direction of movement of the tumble belt. Alternatively or additionally, webs could also be used which extend transversely to the direction of movement of the tumble belt.

It would also be conceivable that—instead of the tumble belt-for example a basket is arranged in the process chamber. The process components can be arranged in the basket.

The basket and/or the tumble belt could, for example, be attached to a frame assembly arranged in the process chamber. This frame assembly can be removed from the process chamber in some examples. For example, the frame assembly could be pivotably arranged so that the tumble belt and/or the basket can be folded out of the process chamber. This can be done for maintenance purposes, for example, or also to unload process parts from the trough of the tumble belt or from the basket. A drive—to rotate the basket or to move the tumble belt—can be arranged, for example, in the blast machine and can be connected to the tumble belt or the basket via a transmission of the frame assembly in order to move them. For example, a locking mechanism of the frame assembly could be used to form a corresponding drive shaft.

If a tumble belt is used in the various examples described herein, a frame assembly could form guide rails or guide channels that extend along the direction of movement of the movement of the tumble belt and guide it. Optionally, it would be conceivable, for example, for these guide channels to extend in the area of the trough, namely where the process components are arranged.

In some examples it would be conceivable that one or more compressed air hoses are arranged in the process chamber. Compressed air can be applied to these one or more compressed air hoses.

When compressed air is applied, the one or more compressed air hoses can perform a chaotic movement in the process chamber. Cleaning can thus take place, for example. In addition, a powder cake could be unpacked.

For example, it would be conceivable that the compressed air hoses are arranged in the trough of a tumble belt in the process chamber or are arranged in a basket if this accommodates the process components in the process chamber.

For example, in some examples a sealing plate could be used to position hand ports arranged in the sealing plate in front of the process chamber. This could be used, for example, in connection with a tumble belt blast machine, but optionally also, for example, in connection with a basket that is arranged in the blast machine.

The sealing plate could optionally be moved in front of the process chamber via a guide rail, for example. However, it would also be conceivable for the sealing plate to be moved in front of the process chamber in some other way.

For example, the sealing plate could in particular interact with a lifting door, which can then rest on an upper edge of the sealing plate.

Different techniques are conceivable for unloading the process components from the process chamber. For example, a carriage that has an unloading container can be used for this purpose. The process parts could, for example, slide into the unloading container via a flap fastened to the carriage. Alternatively or additionally, a chute could also be formed on the blast machine, wherein the chute can be fixedly attached, for example, or can be designed so it can be folded out. Alternatively or additionally, for example, a basket or a tumble belt could also be moved out of a process chamber of the blast machine in order to unload the process parts.

In the various examples described herein, blasting nozzles may be used to blast blasting material into the process chamber. In some examples, a corresponding mount can be provided for one or more blasting nozzles. This mount can be movably arranged inside the process chamber. For example, if a tumble belt having a trough is used, it would be conceivable for the mount to be movably arranged in such a way that the blasting nozzles can be positioned in relation to the trough. For example, a longitudinal movement along the direction of movement of the tumble belt would be conceivable, and/or a transverse movement.

An area in which the process components are arranged—that is, for example, a trough of a tumble belt or a basket—can optionally be subdivided by one or more partition walls according to various examples. The partition walls can be detachably arranged within this area. As a result, the area in which the process components are arranged can be reduced or enlarged as required.

In the various examples described herein, the blast machine can be operated in different operating modes. It is not necessary in all operating modes that blasting material is also actually blasted into the process chamber. For example, in at least one mode of operation, the blasting nozzles could be turned off. Generally speaking, depending on the operating mode, the one or more blasting nozzles could be activated differently. Alternatively or additionally to such a different activation of the blasting nozzles, it would also be conceivable in the various examples described herein for different outlets or outflows from the process chamber to be used in order to remove material from the process chamber. Vibration drive could optionally be activated or deactivated depending on the operating mode. Compressed air could optionally be blown into the chamber depending on the operating mode. A basket or a tumble belt can be driven differently depending on the operating mode.

It would be conceivable for the process chamber to be cleaned in each case between the operating modes, for example by blowing in compressed air, for example by using one or more compressed air hoses. A fan module that cleans a filter of another fan module could also be operated between the operating modes.

In some examples it would be conceivable for an ionization bar to be arranged within a process chamber of a blast machine. This could be surrounded by inert gas or air, for example.

The features presented above and features that are described below can be used not only in the corresponding explicitly presented combinations, but also in further combinations or in isolation, without departing from the scope of protection of the present invention. For example, techniques related to the compressed air hoses can be combined with the use of a tumble belt or even a basket. For example, it would be conceivable that techniques related to the movement of blasting nozzles could be used for both a tumble belt blast machine and a basket blast machine. These are just a few examples, and further variations are conceivable.

### BRIEF DESCRIPTION OF THE DRAWINGS

FIG. 1 schematically illustrates a blast machine according to various examples.

FIG. 2A is a flow chart of an exemplary method.

FIG. 2B illustrates a flap-controlled control of the outflow from a process chamber of the blast machine.

FIG. 2C illustrates a flap-controlled control of the outflow from a process chamber of the blast machine.

FIG. 3 is a perspective view of an exemplary implementation of a process chamber of a blast machine according to various examples.

FIG. 4 is a perspective view of an exemplary implementation of a tumble belt module that comprises a frame and a tumble belt mounted on the frame.

FIG. 5 illustrates details of the frame of the tumble belt module of FIG. 4.

FIG. 6 is a perspective view of the process chamber in which the tumble belt module is used.

FIG. 6 also illustrates details of fans in the process chamber.

FIG. 7 is a perspective view of a lifting door, which can close the process chamber and can be moved to load the process chamber, according to various examples.

FIG. 8 illustrates the use of hand ports in connection with the lifting door according to various examples.

FIG. 9 is a perspective view of an exemplary implementation of a closure plate with hand ports according to various examples.

FIG. 10 illustrates of movement of the tumble belt module within the process chamber according to various examples.

FIG. 11 illustrates a carriage having crates that can be used to load and unload the blast machine.

FIG. 12 illustrates details in connection with the carriage of FIG. 11.

FIG. 13 is a perspective view of a pivotable frame assembly for a tumble belt.

FIG. 14 illustrates details of the arrangement of the tumble belt module in the process chamber according to various examples.

FIG. 15 is a schematic view of the tumble belt according to various examples.

FIG. 16 is a perspective view of a mount for blasting nozzles according to various examples.

FIG. 17 is a flow chart of an exemplary method.

### DESCRIPTION OF THE INVENTION

The properties, features, and advantages of this invention described above, and the manner in which they are achieved, will become clearer and more easily understood in connection with the following description of the exemplary embodiments, which are explained in more detail in connection with the drawings.

The present invention will be explained in more detail hereinafter on the basis of preferred embodiments with reference to the drawings. In the figures, the same reference symbols designate the same or similar elements. The figures are schematic representations of various embodiments of the invention. Elements depicted in the figures are not necessarily drawn to scale. Rather, the various elements shown in the figures are presented in such a way that the function and general purpose thereof can be understood by one skilled in the art. Connections and couplings between functional units and elements shown in the figures can also be implemented as an indirect connection or coupling. A connection or coupling can be implemented as wired or wireless. Functional units can be implemented as hardware, software, or a combination of hardware and software.

Techniques in connection with a blast machine are described hereinafter. The blast machine comprises a housing in which a process chamber is arranged. The process chamber can accommodate process components so that they can be treated using blasting material.

As a general rule, different process components can be processed using the techniques described herein. For example, in one example, metallic process components could be treated. It would also be conceivable to treat plastic components that are obtained in an injection molding method. It would also be conceivable to treat plastic components that were produced using a 3D printing method, for example a powder bed method. The process components, which are produced in a powder-based manufacturing or printing method, can be produced from a material selected from the group comprising polyamide, in particular polyamide 11 and polyamide 12, thermoplastic polyurethane, aluminium-filled polyamide, in particular aluminium-filled polyamide 12, glass-filled polyamide, carbon-reinforced polyamide, sand, plaster, metal, composite material, and combinations thereof. An example of a powder bed method would be a selective laser sintering (LS) method, in which the body of the plastic component is built up step-by-step. Other examples of powder bed methods comprise MJF, high speed sintering, and binder jetting. After completing such a 3D printing method, it is then necessary to separate the plastic components from a powder cake. According to various examples described herein, the separation from the powder cake—sometimes also referred to as unpacking—can be done by means of a blast machine. Unpacking can take place by blasting using compressed air (for example without solid blasting particles). After unpacking, the plastic parts often have residues of powder in cavities, as well as adhesions of thermally influenced powder (sometimes also referred to as caking). Such residues can be removed in so-called depowdering by means of the blast machine. After unpacking and depowdering, the surface can be compacted or homogenized. The surface is homogenized by balls accelerated using compressed air, which equalize the mountains and valleys of the open-pored plastic parts and deform them on a microscopic level. The pores are closed and the result is a significantly improved, uniform surface quality. This is particularly important above all for further processing steps such as a chemical dyeing process in a water bath, in which the dye can soak in evenly. Such a process is called surface homogenization or surface compaction. It is possible that such a surface homogenization is also carried out in the blast machine, for example directly after the depowdering and without the process components having to be removed from the blast machine.

Depending on the area of application, different types of blasting material can be used. For example, the particle size can vary. One example would be blasting material made of plastic, glass, ceramics, or sand having a grain size of 200 μm to 600 μm.

Various techniques described here make it possible to treat plastic components in particular using the blast machine, which—for example in comparison with metal components—are comparatively sensitive to stress. For example, plastic components can break if they fall or rub against each other. The advantage of 3D printing is the great degree of freedom in the design of process components. On the other hand, however, this means that the complexity in the processing of plastic components is increasing. The plastic components typically have to be treated very carefully in order not to damage the surface or geometric elements of the plastic components (due to the high degree of design freedom in additive manufacturing, the plastic components can have filigree and/or sensitive geometric elements). In addition, different ones of the techniques described herein are based on the knowledge that typically a number of plastic components to be processed, which are obtained by a powder bed method, is comparatively small, for example in particular in comparison to metallic components, which are obtained by an injection molding method. If only small batches are blasted—as is often the case for plastic components—the relative consumption of process materials per process component, such as compressed air or blasting material, is high. Due to the possible wide variety of the additively manufactured components, components with different geometries, shapes, sizes, and weights are often processed together, which can also pose a challenge.

The techniques described herein can enable handling the plastic components in a way that avoids damage to the plastic components or at least reduces rejects. Furthermore, according to the various examples described herein, it may also be possible to process comparatively limited batch sizes efficiently. This can affect both the loading process and the unloading process, as well as the blasting process itself, for example the consumption of process materials per process component

Other examples are based on the knowledge that when plastic components are blasted with blasting material, which itself comprises plastic, electrical charges/ionization can occur. These static charges can result in increased adhesion of dirt to plastic components, the process chamber, and other surfaces. This can influence the blasting process and even endanger the operating personnel. Various examples described herein make it possible to reduce the negative effects of charging of plastic components and/or of blasting material and to preclude any danger to the operating personnel.

Various examples are also based on the knowledge that, particularly in connection with the processing of plastic components, it can be desirable to limit the exposure of operating personnel to dust when loading the process chamber. The various techniques described herein can enable a suitable design of the blast machine that limits or reduces dust exposure. Compressed air is often fed into the process chamber in addition to the blasting material. In order not to push the process components (which are particularly light in the case of plastic process components) out of the process chamber, air and solids can therefore be extracted from the process chamber. The blasting material circuit can be closed in this way. In addition, a negative pressure in the process chamber is advantageous in order to prevent powder from escaping from the process chamber. If a large amount of material is extracted per unit of time, blockages can occur. By means of the techniques described herein, the extraction of air can be carried out particularly reliably. Exposure of operating personnel to fine dust is avoided. Blockages of the extraction can be avoided.

Still further examples of the present invention are based on the knowledge that it can often be desirable to blast individual plastic components by hand. For this purpose, hand ports can be provided, which make it possible to move the blasting nozzle to the components manually and/or to manually bring the components to the blasting nozzle or to position them in relation to the blasting nozzle. The techniques described herein enable ergonomic placement of the hand ports so that all areas within the process chamber can be easily and reliably reached. In addition, dirt is prevented from being able to accumulate on the hand ports, which in turn prevents contamination of the process.

Various examples described herein are also based on the knowledge that it can be important to avoid contamination in the process chamber, in particular when processing plastic components that are obtained by a powder bed method. This is the case because otherwise negative effects on further post-treatment steps such as dyeing, chemical smoothing, mechanical smoothing, and/or painting can occur. Various techniques described herein enable the handling of the blast machine so that contamination from the process is avoided. As a result, stable process parameters can be achieved and a consistently high quality of processing of the plastic components can be achieved.

Some of the blast machines described herein may use a tumble belt to move process components within the process chamber. The tumble belt can form a trough in which the process components are arranged. The tumble belt is designed to circulate continuously. By moving the tumble belt in one direction of movement, the parts in the trough are moved (the parts are chaotically turned over) and are each positioned differently in relation to a blasting nozzle. Instead of a tumble belt, however, a basket can also be used, such as a rotary basket.

According to the techniques described herein, maintenance of the tumble belt can be possible in a particularly simple manner. Downtimes of the blast machine can be minimized as a result. Using the techniques described herein, it can also be possible to reach areas in the blast machine for maintenance or cleaning purposes that are inaccessible due to the tumble belt during normal operation.

The tumble belt has a specific width. During the loading process of a front-loaded process chamber, it is then typically necessary to pour the process components through a front opening of the process chamber into the process chamber onto the tumble belt into the trough, for example from a box or another container. For the loading process, the container typically has a width that is smaller than the width of the tumble belt in order to ensure that it can be placed above the trough and process components do not fall down to the side next to the tumble belt. On the other hand, for unloading, it can be desirable to use a container that is slightly wider than the tumble belt so that parts cannot fall down to the side. According to the various examples described herein, the efficient loading and unloading of the process chamber is described, particularly in connection with a tumble belt. Complex individual handling of the process components is avoided. Process components having to cover a long fall distance is avoided, which could otherwise result in damage, in particular for filigree plastic components. By means of the techniques described herein, the loading process and the unloading process can be made particularly simple and reliable.

When using a tumble belt, damage to the plastic components can occur on the part of the tumble belt when using trough wheels. The techniques described herein make it possible to reduce such damage to the process components by movement in relation to moving or fixed parts at the edge of the tumble belt. Plastic components are prevented from getting caught or gaps that are difficult to access and where dirt can collect are prevented. It is possible that the tumble belt (or also the rotating basket) is covered with a carpet or a spaghetti mat. This can be produced from PVC in the colors black or white, but other materials or colors are also conceivable. Possible advantages of covering the tumble belt or the rotating basket with the carpet or the spaghetti mat are that the parts are cushioned when they fall and fall softly, that the mat is permeable to blasting medium and powder, and that there is no abrasion of the mat by the blasting and therefore no contamination of the components.

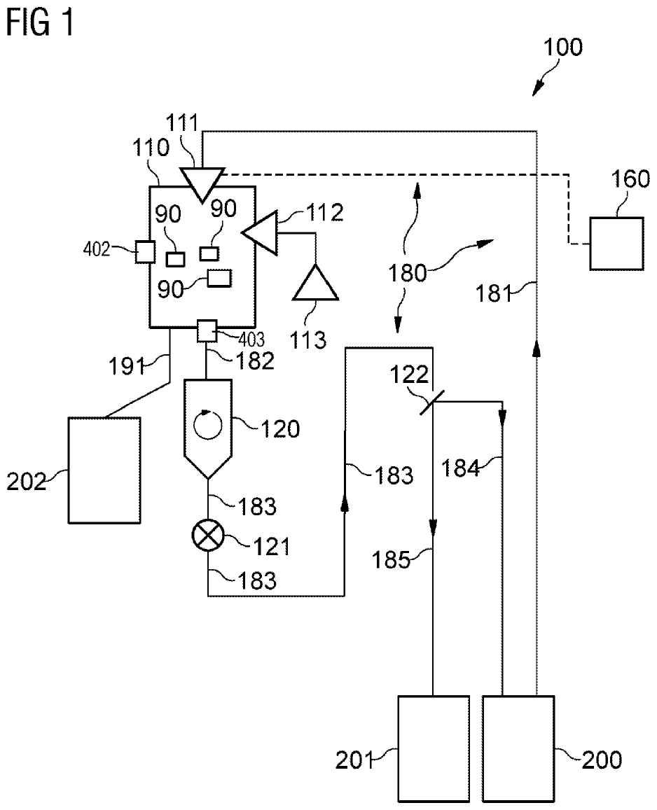

FIG. 1 illustrates aspects in connection with a blast machine 100. The blast machine 100 comprises a process chamber 110 into which the process components 90 can be introduced. The process components 90 are to be blasted using blasting material in order to treat their surfaces. A blasting nozzle 111 is provided for this purpose, which is configured to blast the blasting material into the process chamber 110. While only a single blasting nozzle is shown in the example in FIG. 1, it would generally be conceivable for more than one single blasting nozzle to be used. One or more such blasting nozzles 111 can be attached to a corresponding mount. According to various examples, the mount can be moved in relation to a housing of the process chamber 110. This allows the blasting nozzles 111 to be positioned with respect to the process components 90. This allows the blasting process to be adjusted. Details on this are explained hereinafter in connection with FIG. 15.

FIG. 1 shows that a compressed air source 113 is provided, which can press compressed air into the process chamber 110 via a corresponding outlet 112. It is possible to attach an ionizer in front of or near the compressed air source 113. In this way, ionized air can be distributed in the process chamber 110 and the static charge can be reduced in this way. As a general rule, it would be conceivable that more than one compressed air source 113 and/or more than one outlet 112 is provided. For example, compressed air can be helpful when using a process for unpacking. Unpacking can be promoted by applying compressed air. In addition, compressed air can be helpful for cleaning the process chamber 110. For example, the outlet 112 could be implemented as a compressed air hose. This could, for example, hang in a basket or a trough in which the process components 90 are arranged. When compressed air is applied to it, the compressed air hose performs a chaotic movement and different areas in the basket or trough (for example of a tumble belt) are thus cleaned. The inner walls of the process chamber 110 can also be cleaned. In particular, electrostatically related adhesions of dirt on the inner walls can be efficiently removed by compressed air. Electrostatically related adhesions are observed in particular when processing plastic components 90.

Different compressed air hoses can be used. Various examples described herein are based on the knowledge that, on the one hand, it can be desirable to use a compressed air hose that is as long as possible, since in this way a random movement behavior can be ensured without having to apply a particularly high pressure. On the other hand, a compressed air hose that is excessively long can entail the risk of snagging on the sides of the process chamber 110. Various examples described herein are based on the finding that smaller diameters of the opening of the compressed air hose enable higher pressures and thus promote chaotic movement behavior. An angle on a cut edge at the end of the hose can also be used here to promote random movement behavior. The compressed air hose can be manufactured, for example, from a plastic such as polyurethane. Other materials would be PE or silicone, for example. It has been found that a comparatively soft material promotes chaotic movement and thus enables particularly efficient unpacking. For example, compressed air hoses made of polyurethane having an outer diameter of 4 mm and an inner diameter of 2 mm, and having an outer diameter of 6 mm and an inner diameter of 4 mm, and having an outer diameter of 5 mm and an inner diameter of 3 mm were tested and displayed good behavior. The blasting material is fed via a section 181 of a blasting material circuit 180 from a blasting material container 200. The blasting material can, for example, be sucked in from the blasting material container 200 via a negative pressure by means of the Venturi principle. The blasting material container 200 could, for example, be designed as an interchangeable container, that is to say it could be placed in the blasting material circuit 180 in an interchangeable manner via corresponding mechanical connecting elements.

In the example in FIG. 1, the blast machine 100 has a closed blasting material circuit 180. This means that at least a certain part of the blasting material removed from the blasting material container 200 is returned to the blasting material container 200 by means of the blasting material circuit 180 after it has been used in the blasting process. For this purpose, the blasting material circuit 180 has corresponding sections 182, 183, 184, which lead from the process chamber 110 back into the blasting material container 200. A fan module 403 is provided, which extracts the blasting material and waste, such as residues of powder cake, into the section 182 (outflow). The example in FIG. 1 illustrates that first the blasting material—then mixed with waste (for example powder or powder cake residues and dirt) and air—is transferred via a section 182 of the blasting material circuit 180 from the process chamber 110 into a cyclone 120, where solids are separated from gas or suction air. It would be conceivable here for the suction air to be returned into the process chamber 110 via a fan. At the outlet of the cyclone there is then a collection container 121, namely in the section 183 of the blasting material circuit 180. The collection container 121 forms a cyclone bunker. The collection container 121 is used for the temporary storage of the mixture of blasting material and waste. This solid mixture can then be fed to a separating device 122 via the section 183. The waste (for example the material of a powder cake of a 3D plastic printed component, which was produced using the powder bed process) is then separated from the blasting material at the separating device 122—which can be implemented, for example, by a sieve with a vibrating drive. There is a sluice between the collection container 121 and the sieve, which prevents the cyclone 120 from drawing secondary air, for example from the sieve. The waste is transferred to a waste container 201 via a side section 185 of the blasting material circuit. The blasting material is transferred back into the blasting material container 200 via the section 184 of the blasting material circuit 180. This closes the blasting material circuit. The use of such a closed blasting material circuit 180 is optional. In other examples, it would also be conceivable that the blasting material is not reused. Then, for example, the mixture of waste and blasting material can be returned directly to the waste container 201. In this respect, the separating device 122 is also optional.

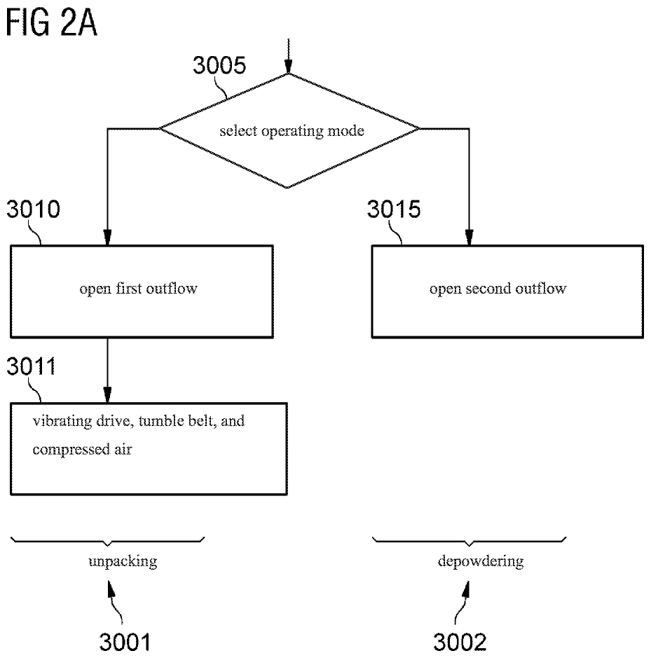

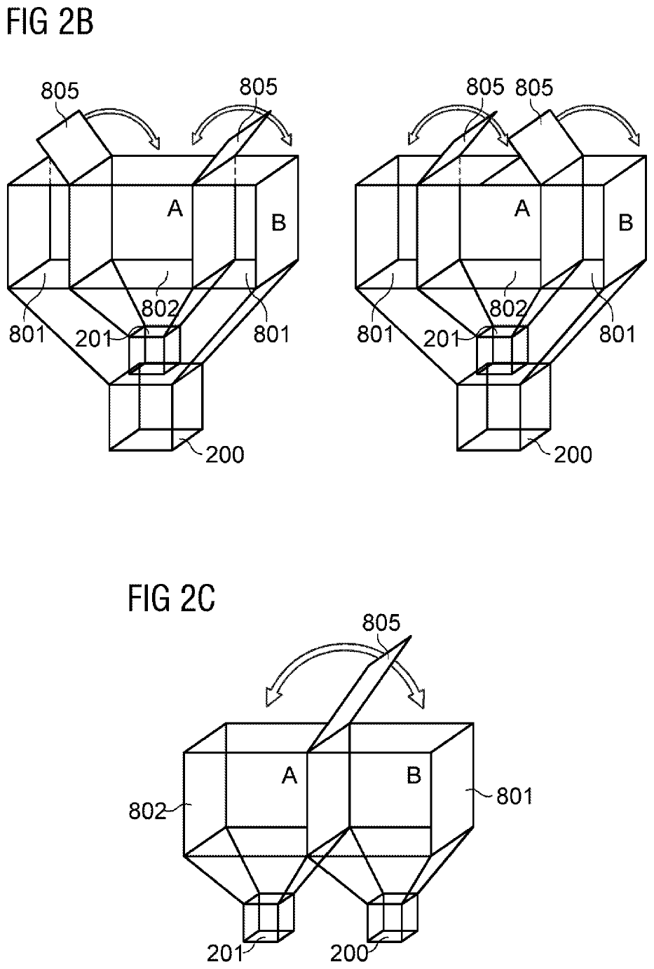

A pinch valve or flaps that form a sluice can be located at the outlet of the collection container. The sluice under the cyclone bunker prevents air from flowing in. Air flowing in could disrupt the separation process of the cyclone and result in premature filter failure. The pinch valves can also assist the screening performance by way of targeted portioning. The sluice can be implemented, for example, by pinch valves, ball valves, rotary sluices, and flaps. The valves are switched in a staggered manner with a certain dead time dT to ensure complete closing. The opening and closing time can be adapted to the respective process requirements. Influences here are: grain size, flowability, static charge, bulk density, grain shape. It would be conceivable, for example, for such a sluice to be operated differently depending on the operating mode (cf. FIG. 2A, as described below).

As a general rule, the provision of the cyclone 120 or the collection container 121 is optional. For example, it would be conceivable that instead of the cyclone 120—or in addition to the cyclone 120—a feed pump for removing material from the process chamber 110 is provided, which can remove the material from the process chamber 110. This can, for example, be combined with a mechanical transport, such as a screw conveyor. In this way, for example, material could be removed from the process chamber 110 without using a cyclone 120 (cf. FIG. 1).

The example in FIG. 1 also shows that in some variants it would be conceivable to use a further outlet from the process chamber 110 in addition to the section 182 of the blasting material circuit 180, here in the form of the line 191. The line 191 leads to a collection container 202 (instead of the collection container 202 there can also be an interface to a powder conveyor or a powder conveyor pump directly, which then conveys to a third-party system (powder processing, etc.)). For example, it would be conceivable for optionally the line 191 or the section 182 to be opened, for example depending on the operating mode of the blast machine 100. For example, it would be conceivable that a control logic 160 activates the blasting nozzle 111 in a first operating mode in order to blast blasting material from the blasting material container 200 into the process chamber 110, and activates it in a second operating mode in order not to blast blasting material into the process chamber 110 or to blast blasting material from another blasting material container (not shown in FIG. 1) into the process chamber 110. In such an operating mode it would be conceivable, for example, to unpack process components 90 from a powder cake. The residues of the powder cake can then be collected in the container 202 when the second operating mode is activated. For example, such residues of the powder cake could then be reused in another powder bed method.

Depending on the operating mode, either the line 191 can then be opened and the section 182 can be closed, or vice versa. In this way it is possible to use the blast machine 100 both for depowdering (1st operating mode) and for unpacking (2nd operating mode). For example, it would be conceivable that the second operating mode is activated first and then—without reloading the blast machine 100—the process components 90 are subsequently depowdered by activating the first operating mode. This reduces the necessary parts handling and the time required to process the process components. Corresponding techniques are also described in more detail in connection with the example in FIG. 2A. In some examples it would be possible, for example, for a surface homogenization (3rd operating mode) to be carried out following the unpacking.

As a general rule, it would be conceivable for intermediate processing to be provided between different operating modes, for example blowing off the process components using air or automated cleaning of the process chamber.

A further fan module 402 is additionally provided in FIG. 1. This is configured, for example, to extract gas/air and dust, especially fine dust, from the process chamber.

FIG. 2A is a flow chart of an exemplary method. For example, the method could be performed by the control logic 160 of the blast machine 100 according to FIG. 1.

First, in block 3005, it is checked whether a first or a second operating mode is selected. Depending on the operating mode selected, block 3010 or block 3015 is then executed. This means that either the outflow 191 from the process chamber 110 is opened, for example in connection with block 3010, or the outflow 182, for example in connection with block 3015. The operating modes can comprise one or more of the following operating modes: unpacking 3001 process components from a powder cake; depowdering 3002 process components; or compacting process components.

As a general rule, different techniques for opening and closing outflows from the process chamber 110 can be used. For example, it would be conceivable to use pinch valves on the various outflows. Alternatively or additionally, collection containers associated with the various outflows could be used. These collection containers can then be opened or closed by flaps, wherein depending on the flap position of a flap, one or the other collection container can be open or closed. This is shown schematically in FIG. 2B, where the collection containers 801 and 802 are alternately opened or closed by the two flaps 805. Still another variant is shown in FIG. 2C. Only one flap 805 is required there.

For example, a surface treatment can be carried out when compacting process components. For example, the surface can be smoothed or homogenized or compacted, i.e., pores on the surface can optionally be closed. Depending on the process, different blasting materials are typically used, and in some processes no blasting material can be used at all. This means that depending on whether block 3010 or block 3015 is executed, different blasting material can also be sucked in from different blasting material containers. For this purpose, the blasting material circuit can comprise different inlets, and it would be conceivable for the control logic 160 to be set up to activate a different inlet in each case.

In connection with the “unpacking” operating mode, it would be conceivable that in block 3011 a vibrating drive for a support of the process components 90 in the process chamber 110 is also activated, for example for a tumble belt, wherein the process components 90 are then located in the trough of the tumble belt. Alternatively or additionally, it could be possible that additional compressed air is injected into the process chamber 110 in block 3011; for example, compressed air blasts could be used.

In some examples, it would also be conceivable that, depending on the operating mode 3001-3002, a motor for a tumble belt on which the process components 90 are arranged is operated in clockwise or counterclockwise rotation.

In some examples, during unpacking in block 3011, it would be possible to measure an amount and/or a volume throughput of recovered powder of the powder cake in the corresponding collection container or in the feed line to the corresponding collection container. Then powder cake could be collected up to a corresponding threshold value in a first collection container. When the threshold value is reached, further residues of the powder cake can be routed into another collection container and the feed line to the first collection container can be closed. In general terms, it would be possible to switch between different collection containers even during an operating mode, depending on the weight in one of the collection containers or depending on the material volume, which was measured by a flow meter. In this way, for example, a distinction could be made between contaminated residues on the one hand and uncontaminated residues on the other. Residues of the powder cake can optionally be reused in another 3-D printing process.

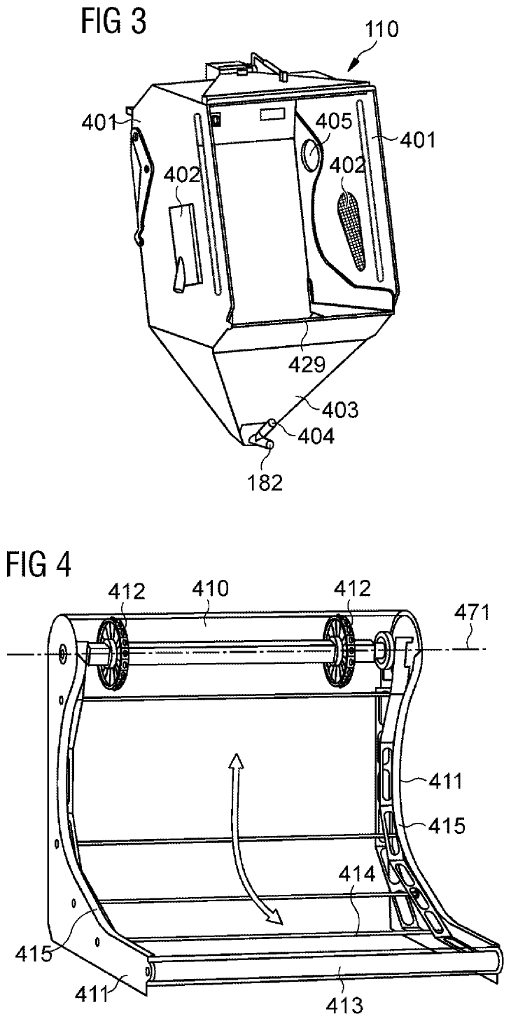

By means of such techniques described in connection with FIG. 2A, it is therefore possible to use different process types, for example unpacking, depowdering, and/or compacting, in the same process chamber 110. Details in connection with the process chamber are described in FIG. 3.

While two operating modes are shown in the example of FIG. 2A, it is generally conceivable to use more than two operating modes. For example, it would be conceivable to additionally or alternatively also use a “surface homogenization” operating mode.

It is generally possible to implement the various operating modes described in FIG. 2A and/or further operating modes sequentially within the same process chamber 110. The process components and/or the process chamber can be cleaned between the activation of the different operating modes, for example by injecting compressed air.

FIG. 3 illustrates aspects in connection with the process chamber 110. FIG. 3 is a perspective view of the process chamber 110. In particular, FIG. 3 shows a housing 401 of the blast machine 100, in which the process chamber 110 is formed, in which a tumble belt can then be used (the tumble belt is not shown in FIG. 3; details of a corresponding tumble belt module will be described later in connection with FIG. 4). A collecting funnel on the bottom of the process chamber 110 feeds material to the outflow 182 (only the outflow 182 is shown in the example in FIG. 3, but it would also be conceivable that another outflow, for example the outflow 191, is provided in addition).

In the example of FIG. 3, the housing 401 is formed by the outside of the process chamber 110. However, an interior of the process chamber 110 could be formed by a separate insert in the housing 401.

In the example of FIG. 3, the process chamber 110 is configured to be frontally loaded, i.e., the process components 90 can be brought into the process chamber 110 or removed from it through the front opening of the process chamber 110.

The process chamber 110 comprises lateral openings so that fan modules 402 can be provided there, which extract gas and/or solids from the process chamber 110. In addition, a fan module 403 is also provided at the bottom of the process chamber 110, which extracts substances such as residues of powder cake that are not in the form of dust or blasting materials into the outflow 182. The fan module 402 is arranged in a side area of the process chamber 110. The fan module 403 is arranged adjacent to the process chamber 110 in the lower area. For example, it would be conceivable that the fan module 403 is arranged outside of the process chamber 110 and sucks in air from an upper opening of the cyclone 120 (cf. FIG. 1).

While the fan module 402 is arranged laterally in the example in FIG. 3, for example, other arrangements for the fan module 402 are also conceivable, for example on the ceiling of the process chamber 110 or on a rear side of the process chamber 110.

A fan module can have a suitable opening toward the interior of the process chamber 110. The fan module can have a filter comprising, for example, replaceable fleece material or a paper filter. The fan module also comprises a fan, for example a radial fan and/or a side channel compressor fan. The filter is arranged between the fan and the process chamber.

The two fan modules 402, 403 are of complementary design in order to ensure that gas and solids are extracted particularly well from the process chamber 110. In particular, the fan modules ensure that the user is not exposed to dust a particularly large amount when loading the blast machine 110, for example. For example, a controller of the blast machine 110 can be configured to operate the fan module 402 and/or the fan module 403 during the loading or unloading of the blast machine 110 (with the lifting door open). Typically, only the fan module 402 is operated when the lifting door is open.

For this purpose, the fan of the fan module 403 has a greater suction power than the fans of the fan modules 402, but can only suck in a lower volume flow of substances. Suction power can refer to the ability to generate negative pressure. In addition to the suction power, the fan can also be characterized by a volume flow. The fan of the fan module 403 can be designed as a side channel compressor, for example, and the fans of the fan module 402 can each be designed as a radial fan. The fans of the fan module 402 can therefore be used to extract dust, in particular suspended dust, directly out of the process chamber 110, which can be helpful in particular during loading/unloading of the process chamber 110 and with an open door in front of the frontal opening of the process chamber 110. While the fans of the fan module 402 can thus essentially remove air/dust, the fan of the fan module 403 can enable the removal of material, such as blasting material, waste, residues of powder cake, etc. Due to the different design of the fans, both functionalities can be enabled particularly well. While the fan of the fan module 403 is optimized for removing solids, the fan of the fan module 402 is optimized for removing air or gas. Dust clouds can be extracted directly at the point of origin. Danger to operating personnel can be avoided. Next, details in connection with the tumble belt that can be introduced into the process chamber 110 will be described.

FIG. 4 illustrates aspects in connection with the tumble belt 410. The tumble belt 410 forms a tumble belt module together with the frame assembly 411. The tumble belt 410 is mounted on the frame assembly 411, which has upper drive or deflection rollers 412 and a lower deflection roller 413. As a result, the movement of the tumble belt (represented by the dashed arrow in FIG. 4) can be made possible. The tumble belt forms a trough 414 in the lower area in the vicinity of the lower deflection roller 413, in which the process components 90 can be arranged during the process. The frame assembly 411 also comprises side panels.

In some examples, it would be possible for the tumble belt module not to have a tensioning roller that applies a tension to individual tumble belt segments in relation to one another. This means that the tumble belt can have a comparatively low pre-tension. It has been observed that such a comparatively low pre-tension of the tumble belt can be helpful, in particular in connection with the processing of plastic process components 90, for example in order to avoid damage to the plastic process components 90.

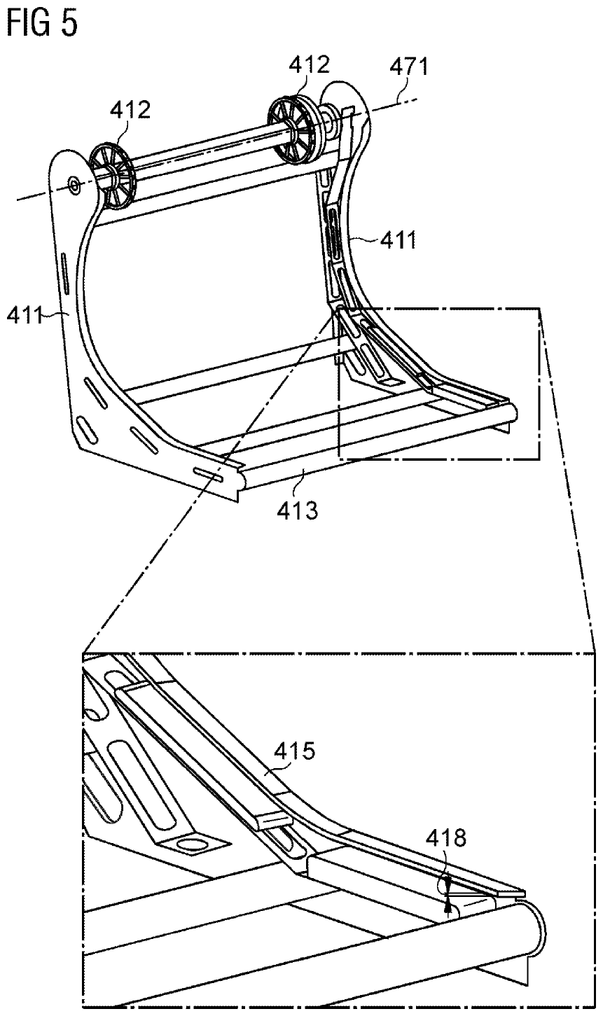

The frame assembly 411 also has guide channels 415 on both sides of the tumble belt 410 extending along the direction of movement. In the example of FIG. 4, these extend between the upper deflection rollers 412 and the lower deflection roller 413; but could generally only extend in an area facing toward the trough 414 (for example, one or more trough wheels could also be used in an area spaced apart from the trough 414). These guide channels 415 are configured to guide the tumble belt 410 during movement. These guide channels (which can also be referred to as guide panels) make it possible to dispense with trough wheels for guiding the tumble belt 410, at least in the area of the trough 414 where the process components 90 are located. This has the advantage that, for example, filigree and small-scale process components 90 (typically plastic process components 90) cannot be pinched by the trough wheels. In particular, the gap dimension 418 (cf. inset of FIG. 5, where the frame assembly 411 is shown without the tensioned tumble belt 410) between the guide channels 415 and the tumble belt 410 can be dimensioned so small that small components 90 cannot be pinched. For example, the gap dimension 418 could be less than 1 cm.

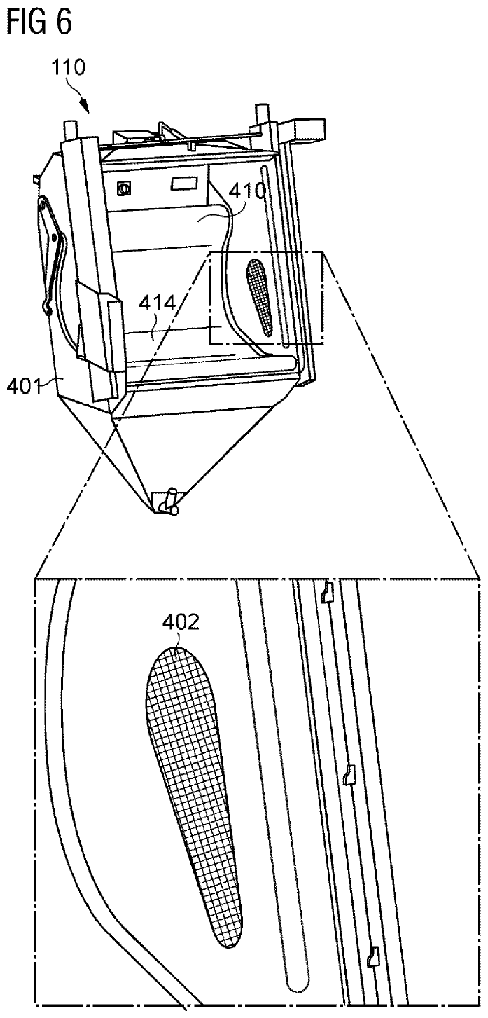

A comparison of FIG. 3 with FIG. 4 shows that the fan modules 402 are arranged in the side panel of the process chamber 110 adjacent to the trough 414, i.e., close to the point at which dust development is to be expected. This is also shown in FIG. 6. In FIG. 6, the tumble belt 410 is arranged in the process chamber 110. In addition, the fan module 402 is shown in the side panel near the trough 414.

In detail, a passage is provided in the housing 401 of the process chamber 110, here in the form of a lattice structure (cf. inset of FIG. 6). The lattice structure could be designed as a sieve, for example. A replaceable filter, which can be configured to filter fine dust particles, can be arranged between a surface of the lattice structure that faces away from the interior of the process chamber 110 and the fan of the fan module 402. For example, a woven material can be used for the filter. By using the lattice structure or the lattice structure, which can be designed as a sieve, and/or the fine dust particle filter, it is possible to avoid the blasting material being sucked in by the fan module 402. The lattice size of the lattice structure could be smaller than the particle size of the blasting material. Instead, the blasting material is extracted by the fan module 403. The fan module 403 could also have a filter. This filter could be cleaned by the fan module 402 in a cleaning mode by sucking in air.

Next, details in connection with the loading and unloading of the process chamber 110 will be described.

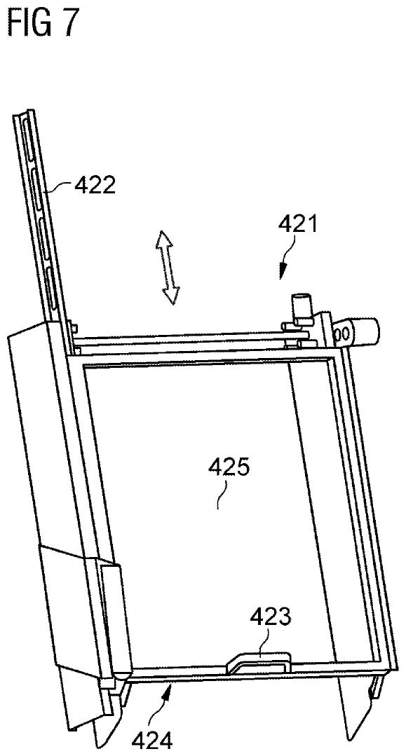

FIG. 7 illustrates aspects related to a lifting door 421. The lifting door 421 can be opened and closed for frontally loading and unloading the process chamber 110. For this purpose, the lifting door 421 can be moved along a rail 422 between a closed position and an open position. The disc 425 then seals the process chamber 110 in the closed position. The disc 425 can be manufactured from a plastic, for example. The disc 425 could have an antistatic and/or scratch-resistant coating. A handle 423 is provided for a user.

In particular, FIG. 7 shows a lower edge 424 of the lifting door 421, which can be formed having a sealing lip, for example. The lower edge 424 of the lifting door 421 can be in contact with a sealing edge 429 of the housing 401 of the process chamber 110 (cf. FIG. 3) to form a seal when the lifting door 421 is in the closed position, so that the process chamber 110 is sealed off.

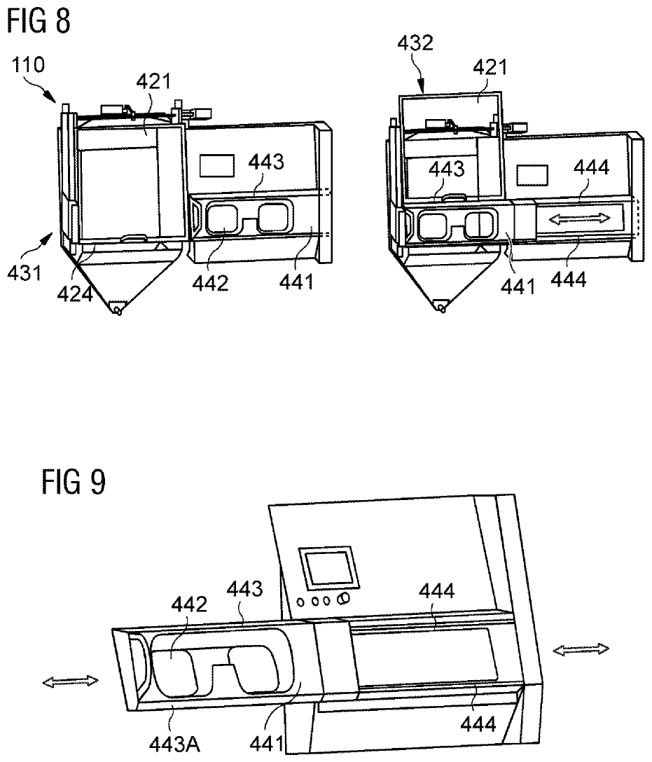

The lifting door 421 can optionally be combined with the use of hand ports arranged in a sealing plate. Corresponding techniques are described in connection with FIG. 8.

FIG. 8 illustrates aspects in connection with the use of a hand port 442. The hand port 442 is arranged in a sealing plate 441. In FIG. 8, on the left, the sealing plate 441 is arranged next to the lifting door 421, which is located there in the closed position 431. In FIG. 8, on the right, the sealing plate 441 is arranged in the area of the lifting door 421, in contrast, which is in an intermediate position 432, i.e., between the closed position 431 and an open position (not shown in FIG. 8; in the open position, the lifting door 421 can be pushed further up). In this state, the lower edge 424 of the lifting door 421 rests on an upper edge 443 of the sealing plate 441, so that the process chamber 110 is once again closed to form a seal.

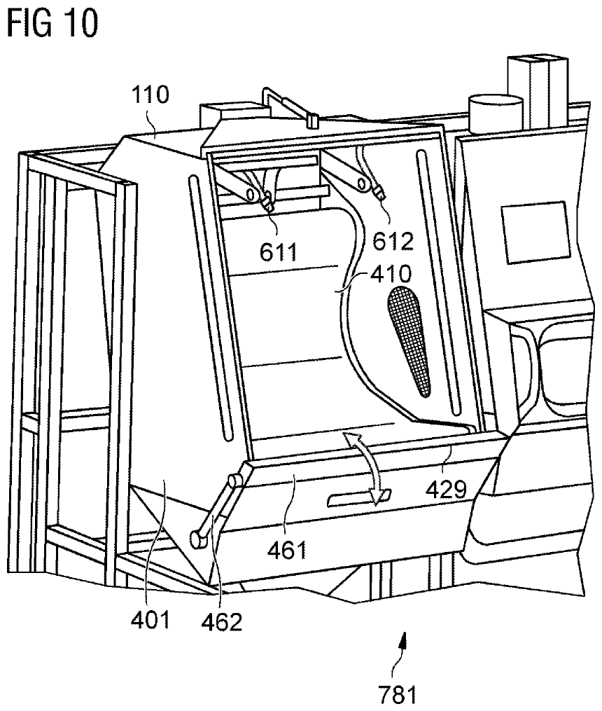

In the example of FIG. 8, guide rails 444 are provided, which extend transversely to the longitudinal direction of movement of the lifting door 421 (indicated by the horizontal double arrow in FIG. 8). The sealing plate 441 is movably (displaceably) arranged in the guide rails 444. This enables the hand ports 442 to be positioned very quickly. Compared to a hand port permanently arranged in the wall of the process chamber, it is advantageous in this case that dirt and powder cannot collect on the hand port, for example in cavities of the hand port or on gloves, which are frequently used. The corresponding displacement of the sealing plate 441 with the hand ports 443 is also shown in FIG. 9.

It is possible that other techniques can be used for positioning the sealing plate 441. For example, it would be conceivable that the sealing plate 441 is positioned manually in the area of the lifting door 421.

Techniques were thus described above as to how it can be possible to open and close the process chamber 110 by means of the lifting door 421. In particular, it was also described in connection with the sealing plate 441 how it can be possible to position the hand ports 442 in the area of the process chamber 110 without particularly great effort. Details relating to the loading and maintenance of the tumble belt 410 will now be described hereinafter.

FIG. 10 illustrates aspects in connection with the tumble belt. FIG. 10 is a lateral perspective view of the process chamber in which the tumble belt 410 is arranged. For the sake of simplicity, the lifting door 421 is not shown.

The example in FIG. 10 shows that the housing 401 of the process chamber 110 has a flap 461 in the lower area of the process chamber 110. In the example of FIG. 10, the sealing edge 429 of the housing 401 is arranged on the flap 461, which is used to form a seal with the lower edge 424 of the lifting door 421 when the latter is in the closed position 431 (cf. FIG. 8; when using the sealing plate 441, the seal is formed between the sealing edge 429 of the housing 401 and the bottom edge 433A of the sealing plate 441, cf. FIG. 9). When the lifting door 421 is in the open position (or the sealing plate 441 is arranged at a distance from the process chamber 110), the flap 461 can be folded out. In some variants, this can be done manually, or—as shown in FIG. 10—by an actuator 462, for example having an electric motor. It is then possible that components 90 which are arranged on the tumble belt 410 can slide out of the process chamber 110 via the folded-out flap 461, for example into a collection container. By using the flap 461 as a parts chute, the falling height of the parts 90 can be reduced, which avoids damage. For this purpose, the direction of movement of the tumble belt 410 can be reversed so that the parts are moved toward the front edge of the process chamber 110.

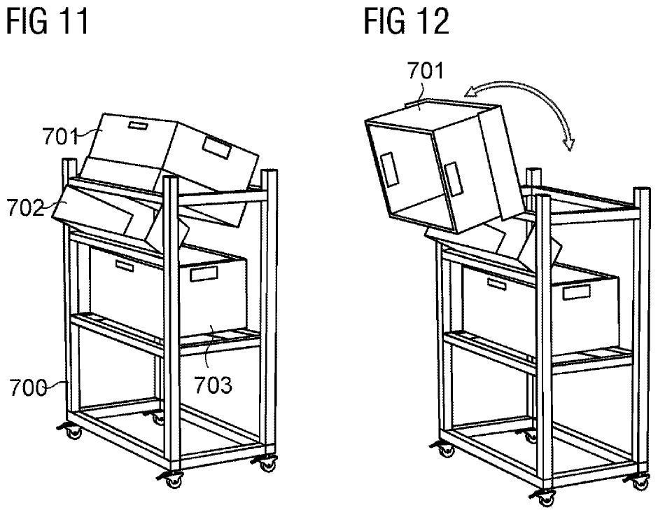

In particular, a suitable carriage can be used for loading and unloading, as described hereinafter in connection with FIGS. 11 and 12.

FIG. 11 and FIG. 12 illustrate a carriage 700 that can be used to load and unload the blast machine 100. The carriage 700 has optional rollers. The carriage can be designed to be movable, but it is also possible for the carriage 700 to be permanently connected to the machine.

The carriage 700 comprises a loading container 701 and an unloading container 703. The unloading container is associated with a slide 702 that can be folded out and is configured to rest on a support surface of the blast machine 100 in the vicinity of the trough 414. For example, the support surface could be formed by the flap 461. When the process components 90 are unloaded from the trough 414, the process components 90 can then slide over the flap 461 into the unloading container 703. Again, this avoids the process components 90 having to overcome a large fall height. In addition, the chute 702 has lateral guide panels that narrow towards the unloading container 702. As a result, the process components 90 can be guided into the unloading container 702 by a type of funnel. This can be particularly advantageous if containers having the same width are to be used for loading and unloading.

Instead of an integrated flap 461, it would also be conceivable to manually hang the flap 461 on a corresponding contact feature of the process chamber 110.

Alternatively or additionally to such a funnel-shaped chute 702, other or further measures could also be taken in order to convey process components 90 safely from the trough 414 into the unloading container 703. For example, wedges could be attached to the sides of the process space 110, which guide the parts in a defined width corresponding to the width of the unloading container 703. A mechanism comprising paddles that are pivotable away would also be conceivable, which guide the process components 90 away from the edges of the tumble belt 410 during unloading. Finally, it would also be conceivable to use blasts of compressed air to center the parts within the trough 414 during unloading, by providing appropriate compressed air nozzles at the edges of the tumble belt 410.

The loading container 701 can be tipped, as shown in FIG. 12, in order to convey the process components 90 onto the tumble belt 410. The width of the loading container 701 can be less than the width of the tumble belt 411 transversely to the direction of movement, so that the loading container 701 can be tipped into the process chamber 110. While in the example of FIG. 12 the loading container 701 is tipped in the same direction as the chute 702 is located, it would also be conceivable for the loading container 701 to be tipped on the other side of the carriage 700. This can be advantageous if dust is thrown up during tipping, which could soil the parts chute.

In some examples, it would be conceivable for the carriage 700 to have contact features (for example a latching closure) which releasably engage with corresponding contact features of the blast machine, for example on the housing 401 of the process chamber 110, to ensure defined positioning of the carriage 700 in relation to the process chamber 110 during loading and/or unloading.

Such contact features can also be embodied redundantly to allow positioning in different positions of the carriage 700 relative to the blast machine. This means that the carriage can also be used as part of a safety concept, so that the risk of injury by the user, for example from limbs that are pulled into the tumble belt, is avoided.

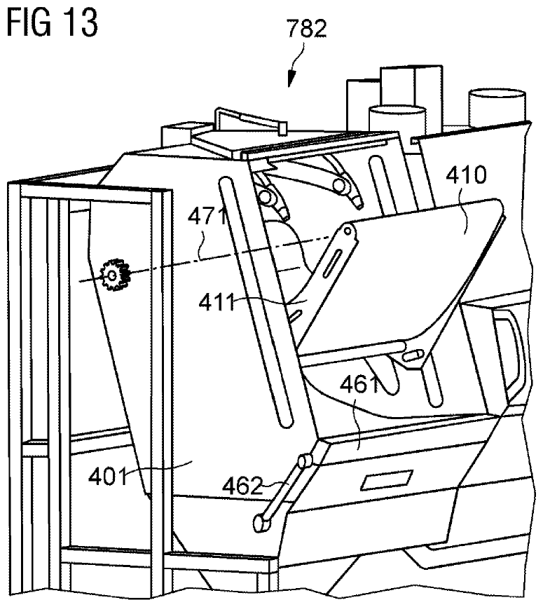

It is not necessary in all variants for the housing 401 of the process chamber 110 to have the flap 461. The process components 90 can also be unloaded from the trough 414 manually or directly onto a corresponding flap of the carriage 700, optionally with a chute permanently attached to the housing 401 and/or can also be implemented by pivoting the tumble belt module comprising the frame 411 and the tumble belt 410. A corresponding technique is discussed below in connection with FIG. 13.

FIG. 13 illustrates aspects in connection with the tumble belt 410. In the example of FIG. 13, the frame assembly 411 for the tumble belt 410 is arranged to be pivotable around a pivot axis 471 (cf. also FIG. 4 and FIG. 5) in relation to the housing 401 of the process chamber 110. The pivot axis 471 is located in the area of the upper deflection rollers 412 of the frame assembly 411. In particular, the frame assembly 411 can be arranged to be pivotable between an operating position 781 (as shown in FIG. 10) and a maintenance position 782 (as in FIG. 13). In the maintenance position 782, the lower area of the process chamber 110 is accessible and can be cleaned, for example.

In addition to such a functionality for promoting the accessibility of the process chamber 110 by pivoting up the frame assembly 411, further positive effects can be achieved by the pivotable frame assembly 411.

For example, in order to unload the process chamber 110, it is possible for the tumble belt 410 to be pivoted forward out of the operating position—in the direction of the maintenance position 782, into an intermediate position (not shown in FIG. 10 and FIG. 13)— so that a front edge of the tumble belt 410 defined by the front deflection roller 413 is arranged in front of the sealing edge 429 of the housing 401, i.e., it protrudes from the process chamber 110. Then the parts chute 702 of the carriage 700 or the unloading container 703 directly could be arranged below this front edge of the tumble belt 410 in order to enable the process components 90 to be unloaded in this way. In such a case, it may not be necessary in particular to provide the flap 461.

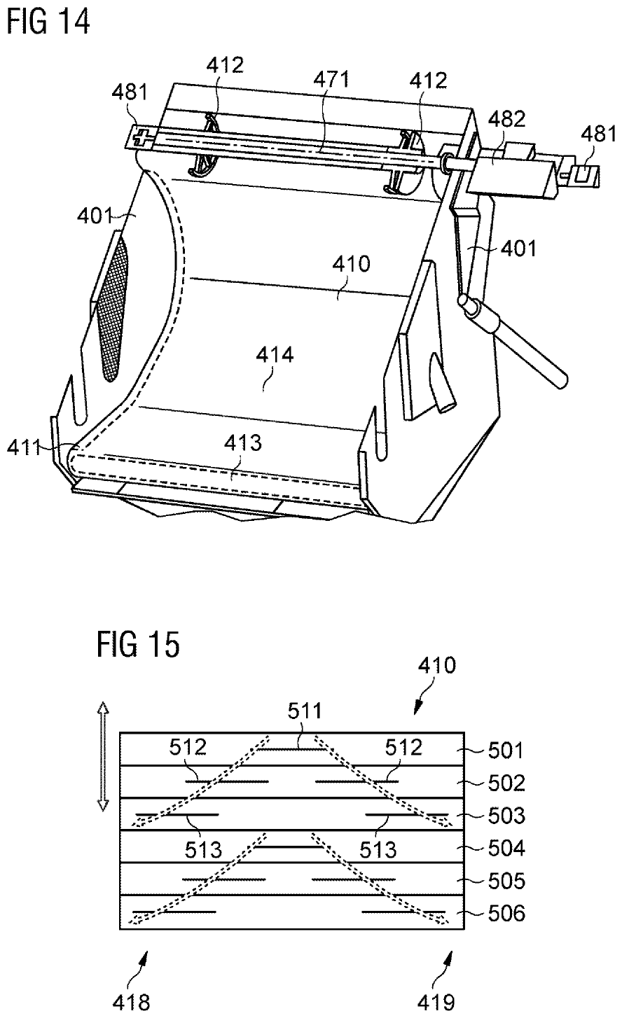

Still another effect of the frame assembly 411 that can be folded out is that the tumble belt 410 can be removed particularly easily from the process chamber 110 together with the frame assembly 411 when it is arranged in the maintenance position 782 (cf. FIG. 13). This is because a locking mechanism 481, as shown in FIG. 14, can be provided for this purpose. In the example of FIG. 14, the locking mechanism is implemented via a locking cylinder. The locking mechanism 481 is configured to alternately lock or unlock an engagement between the frame assembly 411 for the tumble belt 410 and the housing 401 of the process chamber 110. When the frame assembly 411 is arranged in the maintenance position (cf. FIG. 13), the engagement between the housing 401 and the frame assembly 411 can be unlocked. The frame assembly 411 can then be removed from the process chamber 110 together with the tumble belt 410. The removal can take place in the direction of the front lifting door 421, due to which no opening in the housing 401 on the side of the process chamber 110 is required. As a result, the process chamber 110 can then be particularly accessible and cleaning can be made possible. It would also be conceivable to exchange the tumble belt 410 or to configure it differently. Accessibility to components inside the process chamber is made easier, which can be advantageous for maintenance and inspection.

The example in FIG. 14 also shows that a motor 482 is connected to the upper deflection rollers 412 via a drive shaft or actuator formed by the locking mechanism 481. For this purpose, a passage 405 is provided in the housing 401 (cf. FIG. 3). The motor 482 is connected to the housing 401 and can therefore remain stationary when the frame assembly 411 with the tumble belt 410 is removed from the process chamber 110 for maintenance purposes, for example.

With such a design, the tumble belt module comprising the tumble belt 410 and the frame assembly 411 can be quickly removed from the process chamber 110. This reduces the downtime of the blast machine 100, which is required for maintenance of the tumble belt module. For example, it would be conceivable to insert a replacement tumble belt module directly or to repair the existing tumble belt module at an ergonomic working height outside of the blast machine 100.

Details of the tumble belt are also shown in FIG. 15.

FIG. 15 illustrates the tumble belt 410 schematically. FIG. 15 is a top view of tumble belt 410. The direction of movement of the tumble belt 410 is oriented vertically in the plane of the drawing of FIG. 15, as indicated by the double arrow.

The tumble belt can be made of an antistatic material (such as an acetal copolymer). Typically, the electrostatic charge can be created by dissipating charge, i.e., due to low ohmic resistance of the material, or by reducing friction.

The tumble belt 410 is composed of tumble belt segments 501-506 which are detachably connected to one another. For example, clip connections could be used. In the example of FIG. 15, the various tumble belt segments 501-506 each comprise webs 511-513 which are oriented perpendicularly to the direction of movement, i.e., protrude perpendicularly from a surface defined by the various segments 501-506. The webs 511-513 can be detachably attached to the surface of the tumble belt 410. For this purpose, contact features can be provided on the surface of the tumble belt 410 and on a corresponding underside of the webs 511-513. For example, a detachable plug connection could be implemented by the contact features. Instead of webs, differently shaped elements can also be used, for example pins, cuboids, or hemispheres.

The tumble belt can have properties that enable longevity, stabilize the process, are easy to clean, and comply with the safety concept. A durable material such as polyoxymethylene or an acrylonitrile-butadiene-styrene copolymer can be used for this purpose. The material can optionally have electrical conductivity <=10\hat{ }9 ohm. A conductivity <=10\hat{ }6 ohm can be especially helpful in avoiding material adhering to the tumble belt. A polyoxymethylene, for example, in a natural color (usually white) can be used to minimize the influence of soiling from abrasion.

The example in FIG. 15 shows that the various webs 511-513 are arranged on the tumble belt 410 in such a way that they cause the process components 90 to move perpendicularly to the direction of movement of the tumble belt 410 towards the sides of the tumble belt 410. This is achieved by the pyramidal arrangement of the webs 511-513 (i.e., a process component is moved by the web 511 toward an edge of the tumble belt 410, then further to this edge by one of the webs 512, etc.; this is represented in FIG. 15 by the dotted arrow). The webs 511-513 could, for example, also be arranged diagonally to the direction of movement in order to promote a corresponding effect of the “left/right distribution” of the process components 90 within the process chamber 90 between the two sides 418 and 419 of the tumble belt 410. Also, a back-and-forth movement of process components could be enabled from one side of the tumble belt to the other, or from the sides of the tumble belt to the center of the tumble belt and back.

While techniques have been described above in which the webs 511-513 can be variably attached to the tumble belt segments, it would also be conceivable in other examples for the webs 511-513 to be fixedly attached to the tumble belt segments; then a configuration of the webs 511-513 as shown in FIG. 15 could be achieved by suitable selection of the tumble belt segments having the fixed webs 511-513.

By using such webs 511-513 or other elements which are configured to distribute the process components 90 perpendicularly to the direction of movement of the tumble belt 410 when the tumble belt 410 moves, a particularly uniform process control can be achieved, especially for small process components in a front-loaded process chamber 110 as discussed.

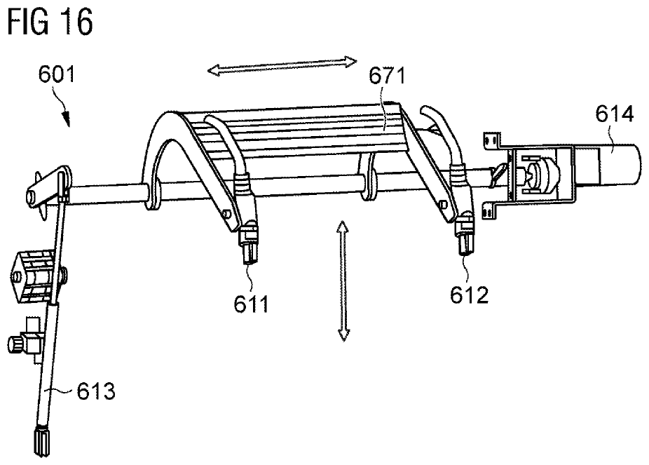

In particular, process components 90 can be blasted particularly uniformly. Corresponding effects of uniform blasting of the process components 90 can also be achieved by the suitable implementation of blasting nozzles. Techniques in this regard are discussed in FIG. 16.

FIG. 16 illustrates aspects in connection with blasting nozzles 611, 612. The blasting nozzles 611, 612 can correspond to the blasting nozzle 111 (cf. FIG. 1). As a general rule, one or more blasting nozzles can be used in the blast machine 110.

FIG. 16 illustrates in particular a mount 601 on which the blasting nozzles 611, 612 are attached. In the example of FIG. 16, the mount 601 is rod-shaped.

The mount 601 is arranged in the upper area of the process chamber (cf., for example, FIG. 10, where the blasting nozzles 611, 612 are also shown).

The mount is movably arranged relative to the trough 411 formed by the tumble belt 410. This means that the blasting nozzles 611, 612 can be positioned alternately closer or farther away from the process components 90 that are arranged in the trough 414. This allows the intensity of the blasting process to be adjusted. This enables a particularly finely tuned process control, as can be helpful, for example, in connection with the use of plastic process components 90.

Alternatively or additionally to such a change in the distance between the blasting nozzles 611, 612 and the process components 90, it would also be conceivable for the angle of the blasting nozzles to change relative to the trough 414.

In one example, it would be conceivable that the blasting nozzles 611, 612 are positioned by manually moving the mount 601 with respect to the trough 414, for example when the lifting door 421 is arranged in the open position. In the example of FIG. 16, an actuator 613, for example an electric motor, is provided, which can adjust the mount 601 automatically. Then it would be conceivable that the control logic 160 (cf. FIG. 1) is configured to activate this actuator 613 in order to move the mount 601.

Alternatively or additionally to such an automated movement of the mount 601, a manual movement could also take place. A lever outside of the process chamber 110 can be provided for this purpose, for example.

As a general rule, different degrees of freedom of movement of the mount 601 can be implemented. For example, it would be conceivable that an up-down movement is carried out, i.e., towards or away from the trough 414 (illustrated by the vertical dashed arrow in FIG. 16). Alternatively or additionally, a left-right movement could also be carried out, i.e., in parallel to the trough 414 (illustrated by the horizontal dashed arrow in FIG. 16). The blasting nozzles 611-612 or the entire mount 601 (also referred to as a jet bar) could also be tilted or rotated in some examples.

Different control variables are conceivable here, which are used by the control logic 160 to activate the actuator 613 in order to move the mount 601. Some exemplary control variables are discussed hereinafter. As a general rule, multiple control variables can be taken into consideration, or control variables other than those listed below.

For example, it would be conceivable that a different position of the mount 601 is set depending on the operating mode (cf. FIG. 2A). For example, during unpacking, the distance between the —then switched off—blasting nozzles 611-612 and the process components 90 could be increased in order to avoid contamination of the blasting nozzles 611-612.

For example, in a cleaning mode of operation, an “electric eel movement” could be performed by the mount 601. Compressed air can then be used particularly efficiently for cleaning via the blasting nozzles.

Alternatively or additionally, it would also be possible to position the mount 601 depending on the positioning of the frame assembly 411 for the tumble belt 410. If, for example, the frame assembly 411 is folded out into the maintenance position (cf. FIG. 13), it would be conceivable that the mount 601 is positioned far away from the bottom of the process chamber 110 so that the frame assembly 411 can be folded far up. In such examples, it would therefore be conceivable that the control logic 160 is configured to activate the actuator 613 so that it moves the mount 601 toward the trough 414 or away from the trough 414. This can correspond to the up and down movement within the process chamber 110. In addition to control by an actuator and the control logic, mechanical coupling of the tumble belt module and the mount 601 is also conceivable, which causes a joint movement when the tumble belt module is folded up.

Techniques have been described above which enable movement of the bracket 601 towards or away from the trough 414 semi-dynamically, for example depending on the operating mode or depending on whether the lifting door is in the closed or open position or depending on whether a blasting process is being carried out or is not being carried out. In some examples, dynamic regulation of the vertical position of the mount 601 in relation to the trough 414 would also be conceivable. The control variable can change here during the processing of the process components 90. A distance sensor (such as a TOF camera, a LI-DAR sensor, an ultrasonic sensor, a stereo camera, etc.) could be provided for this purpose, for example, which determines a distance between the mount 601 and the process components 90 in the trough 414. Then, the control logic can be configured to form a control loop in order to regulate this distance to a setpoint value by moving the mount 601 toward the trough 414 or away from the trough 414 while the tumble belt 411 is moving. A blasting process could also carry out a predefined movement of the mount 601 or blasting nozzles 611-612, independently of the number and size of the process components 90.

As a result, it can be ensured, for example with comparatively few process components 90 in the process chamber 110, that a stable distance between the blasting nozzles 611-612 and the process components 90 is maintained and thus reproducible results can be achieved during the blasting.

Such a setpoint value of the control loop can be defined statically or dynamically. A static setpoint value can remain constant during the blasting process, for example. However, it would also be conceivable to use a dynamic setpoint value that assumes different values during the blasting process.

In addition to such a vertical movement of the mount 601, a horizontal movement (i.e., perpendicular to the emission direction of the blasting nozzles 611, 612) would also be conceivable. The control logic 160 could therefore be configured to control the actuator 613 so that it moves the mount 601 transversely to the direction of movement of the tumble belt. In some examples, a separate actuator 614 could also be provided for this purpose. Such a transverse movement can also ensure that process components 90 arranged laterally in the trough 414 are reliably blasted. For this purpose, for example, a corresponding horizontal movement could be carried out periodically. In this way, the entire width of the tumble belt 410 can be covered during the blasting, even if the opening angles of the blasting nozzles 611, 612 are comparatively smaller.

Complex movement patterns are also conceivable, in which different degrees of freedom of movement (e.g., rotation of the blasting nozzles 611-612 and translational movement of the mount 601, for example forwards and backwards or right/left) are applied superimposed.

Alternatively or additionally to such a periodic horizontal movement of the mount 601, it would also be conceivable to achieve a static left-right positioning of the blasting nozzles 611, 612 transversely to the direction of movement of the tumble belt 410. For this purpose, a partition wall could be provided, for example, which extends along the direction of movement of the tumble belt 410 and which is arranged in order to divide the process chamber 110 into two areas. For example, these areas can correspond to left and right. In this case, it would be conceivable for the partition wall to be arranged in a stationary manner in the process chamber 110 or for example to be attached to the tumble belt in the form of webs along the running direction of the tumble belt 410. If the partition wall is arranged in a stationary manner in the process chamber 110, the partition wall can be, for example, flexible contact elements, for example bristles, attached in a contact area with the tumble built 410. The control logic 160 can then be configured to control the actuator 613-614 in a corresponding operating mode, so that the movement of the mount 601 is positioned transversely to the direction of movement of the one or more blasting nozzles 611, 612 in one of the two areas formed by the partition wall.

In that the process chamber 110 is divided into two parts by the partition wall, it is possible for less consumable material, in particular compressed air, to be required for the process control, in particular when comparatively few process components 90 are arranged in the process chamber 110. The blasting nozzles 611, 612 can still be suitably positioned in either of the respective areas.

As a general rule, such a partition wall can also be used without a left-right moveable mount 601 for the blasting nozzles 611-612 being provided. For example, it would be conceivable that only one of the two blasting nozzles 611, 612 is activated in each case, depending on whether process components 90 are arranged in the left part or in the right part of the process chamber 110.

FIG. 16 also illustrates that an ionization bar 671 is also attached to the mount 601—in addition to the blasting nozzles 611-612. The ionization bar 671 can be moved together with the blasting nozzles 611-612 when the mount 601 is moved. While in the example of FIG. 16 the ionization bar 671 is fastened together with the blasting nozzles 611-612 by a single mount 601, it would be conceivable in other examples for the ionization bar 671 and the blasting nozzles 611-612 to be fastened to different mounts, wherein these different mounts can also be moved separately.

When blasting process components, blasting material is conveyed onto components, for example by means of a carrier medium (for example air). A turbine or centrifugal wheel could also be used. Material is removed from the component by the introduction of energy (especially when depowdering plastic components additively manufactured in the powder bed method). During the blasting process, a mixture of air, intact blasting material, damaged blasting material/blasting material residue (here summarized under dirt), and material particles/powder from the component thus results. In combination with oxygen, solid particles can explode under certain circumstances (so-called dust explosion). This is possible if the dust consists of combustible material and falls below a certain particle size, for example 0.5 mm. Due to the correspondingly large surface, the dust particles can absorb heat well and oxidize quickly after ignition. Another decisive factor is the dusting behavior of bulk materials. An ignition spark in combination with a dust cloud therefore has to be avoided in blast machines.

Another problem is electrostatic charging (the occurrence of electrical charges on the surface of non-conductive materials) of solid particles such as powder or blasting material, for example induced by friction. When two bodies come into contact, a charge transfer occurs on the surface, which can result in a charge displacement. After separating the bodies, this displacement can partially remain. The biggest factors are the separation speed and the conductivity of the bodies. High separation speeds and low conductivity impair charge equalization. The resulting charge can result in powder deposits in the blasting cabinet, for example.

Static charging is usually reduced by ionization, increasing the ambient humidity, suitable material pairing, or ESD— passive dissipation of charges. In practice, a combination of the aids mentioned is usually found. In order to reduce electrostatic charging, it is prior art to use ionizers. Free ions and electrons are generated which neutralize the charge by recombination. Active ionizers are often used in blast machines, which generate an electrical field at pointed electrodes and thus the air in the surroundings is ionized. The ionized air can then be accelerated onto the powder. In the worst case, the high voltage can ignite a dust cloud. The blasting process and the blow-off process using ionized air are therefore often separated in time. This allows the zone in the process chamber to be reduced from zone 20 to zone 21 according to IEC (zone 20: area in which an explosive atmosphere in the form of a cloud of combustible dust in air is present continuously, for a long time, or frequently; zone 21: area in which it is to be expected that an explosive atmosphere in the form of a cloud of combustible dust in air will occasionally occur during normal operation.) Depending on the zone, certain precautions and measures for explosion protection then have to be taken.

By using the ionization bar 671, it is possible to create a local flushing of the ionization with air or another protective gas. The ionization bar is implemented by a non-explosion-proof ionization rod. This can be arranged in the process space 110—for example with ATEX zone 20—by flushing the partially enclosed rod continuously with clean and dust-free air; for example, process exhaust air from the fans of the machine could be used. Instead of air, however, other gases are also possible, for example inert gas, such as nitrogen. A local reduction/avoidance of a potentially explosive zone can be achieved in this way. This makes it possible to reduce restrictions in the choice of the ionization. For example, it may be possible to use non-explosion-proof ionization and use ionization during the blasting process or other process steps in which dust is present.

It is also possible to flush other components in the process space to enable the use of non-explosion-proof components, such as motors.

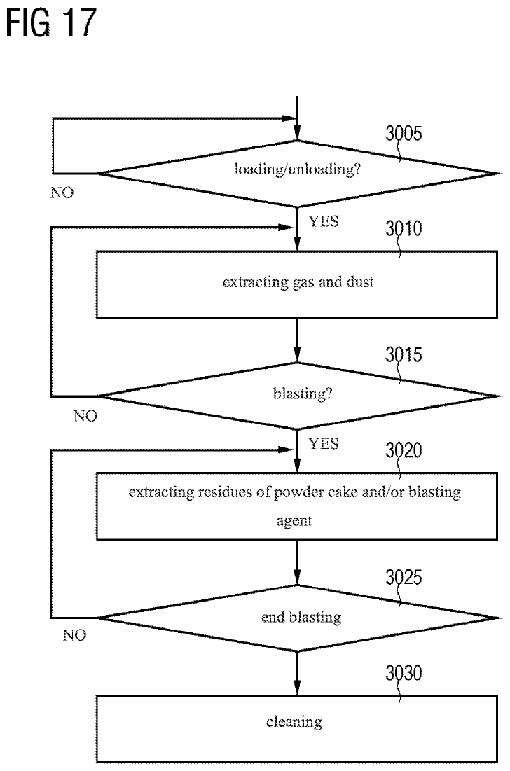

FIG. 17 is a flowchart of an exemplary method. The method of FIG. 17 may be carried out by a control logic, such as the control logic 160. The method of FIG. 17 is used to operate multiple fans of a blast machine for plastic components that were produced, for example, by means of 3D printing.

In box 3005 it is checked whether the blast machine is currently being loaded. If the blast machine is currently being loaded, gas, in particular air, is extracted from the process chamber in box 3010 (when the loading door is open). In addition, dust, in particular fine dust, is extracted. For this purpose, a second fan can be activated and operated, which is set up to extract a particularly large volume flow. For example, a radial fan could typically be used. The radial fan can have a comparatively low suction power, for example in comparison to a side channel compressor. In this way it can be avoided that dusty powder residues of the plastic components from the manufacturing process escape into the ambient air when loading the blast machine and cause pollution of the ambient air. When the machine is loaded, it can be checked in box 3015 whether the plastic components are blasted. For example, unpacking or depowdering could take place.

If blasting is then carried out, solids can also be extracted in box 3020. For example, residues of powder cake could be extracted during the unpacking. During the depowdering, the blasting agent and/or waste, i.e., for example, thermally contaminated powder, can be extracted, for example in order to reuse the blasting agent. Residues of powder cake could also be reclaimed during the unpacking.

In box 3020, a correspondingly configured first fan can be activated and operated to extract the blasting agent and/or the residues of powder cake, for example a side channel compressor, which has a comparatively high suction capacity while at the same time having a small volume flow (in comparison to the second fan). Solids can be extracted particularly well in this way.

In addition, the second fan can also be activated in box 3020 in order to generate a negative pressure in the process chamber of the blast machine. This prevents the particularly light plastic components from being pushed out of the process chamber when compressed air with blasting particles is blown into the blast machine during blasting.

It is then checked in box 3025 whether the blasting is ended. When the blasting is finished, in box 3030 a filter of the fan module of the first fan used in box 3020, which extracts solids, can be cleaned. The second fan can be used for this purpose. For example, the second fan can be connected to a cleaning port of the filter of the fan module of the first fan and then operated to clean a corresponding filter.

In summary, the following examples in particular were described above:

### Example 1: A Blast Machine (100) which Comprises

a housing (401),
a process chamber (110) formed in the housing (401),
at least one first fan (403), which is configured to extract substances from the process chamber (110) using a first suction capacity and a first volume flow, and
at least one second fan (402), which is configured to extract substances from the process chamber (110) using a second suction capacity and a second volume flow,

wherein the first suction power is greater than the second suction power,

wherein the first volume flow is less than the second volume flow.

### Example 2: The Blast Machine According to Example 1

wherein the first fan (403) is designed as a side channel compressor and wherein the second fan (402) is designed as a radial fan.

### Example 3: The Blast Machine (100) According to Example 1 or 2, which Furthermore Comprises

a tumble belt (411) which is arranged in the process chamber (110) and which forms a trough (414),
wherein the second fan is optionally arranged in a side panel of the process chamber (110) next to the trough (414) or on a ceiling of the process chamber (110) or in a rear wall of the process chamber (110).

### Example 4: A Blast Machine (100) which Comprises

a housing (401),
a process chamber (110) formed in the housing (401),
a compressed air hose, which is arranged in the process chamber (110), and
a source of compressed air that is configured to apply compressed air to the compressed air hose so that it performs a chaotic movement in the process chamber.

### Example 5: A Blast Machine (100) which Comprises

a housing (401),
a front-loaded process chamber (110) formed in the housing (401),
a tumble belt (411) which is arranged in the process chamber (110) and which forms a trough (414),
a lifting door (421) which is arranged in front of the process chamber (110) and which can be moved along a longitudinal direction between a closed position and an open position, wherein a lower edge (424) of the lifting door (421) in the closed position rests on a sealing edge of the housing (401), so that the process chamber (110) is closed to form a seal, and
a sealing plate (441) having an upper edge and a lower edge, wherein the sealing plate (441) can be detachably arranged such that the lower edge of the sealing plate (441) rests on the sealing edge (429) of the housing (401) and the lower edge of the lifting door (421) rests on the upper edge of the sealing plate (441) when the lifting door (421) is located in an intermediate position between the closed position and the open position such that the process chamber (110) is closed to form a seal, wherein one or more hand ports (442) or arranged in the sealing plate (441).

### Example 6: The Blast Machine (100) According to Example 5, which Furthermore Comprises

a guide rail (444) arranged in the housing (401) and extending transversely to the longitudinal direction of movement of the lifting door (421),

wherein the sealing plate (441) is movably arranged in the guide rail (444).

### Example 7: The Blast Machine (100) According to Example 5 or 6

wherein the sealing edge (429) of the housing (401) is formed on a flap (461) of the housing (401) which can be folded out when the lifting door (421) is not in the closed position,

wherein the flap (461) is arranged in relation to the tumble belt (414) in such a way that process components (90) can slide out of the trough (414) via the flap (461).

### Example 8: A System which Comprises

a blast machine (100) having a process chamber (110),
a carriage (700) having a chute (702), which can be folded out and which is configured to rest on a support surface of the blast machine (100) when process components slide from the process chamber (110) into an unloading container (703) of the carriage (700).

### Example 9: A Blast Machine (100) which Comprises

a housing (401),
a process chamber (110) formed in the housing (401), and
a frame assembly (411) for a tumble belt (414), which has an upper deflection roller (412) and a lower deflection roller (413) and which is configured to guide a movement of the tumble belt (414).

### Example 10: The Blast Machine (100) According to Example 9

wherein the frame assembly (411) is arranged to be pivotable between an operating position (781) and a maintenance position (782) around a pivot axis (471) arranged in the area of the upper deflection roller (412).

### Example 11: The Blast Machine (100) According to Example 10, which Furthermore Comprises

a locking mechanism (481) for the frame assembly (411), which is configured to unlock an engagement between the housing (401) and the frame assembly (411) when the frame assembly (411) is arranged in the maintenance position (782), and
a motor, which is connected to the upper deflection roller (412) via a drive shaft formed by the locking mechanism (481).

### Example 12: The Blast Machine (100) According to any One of Examples 9 to 11

wherein the frame assembly (411) furthermore has guide channels channels which extend along a direction of movement of the tumble belt (414) in an area facing toward a trough (414) formed by the tumble belt (414) and which are configured to guide the tumble belt (414) in the movement.

### Example 13: A Blast Machine (100) which Comprises

a housing (401),
a process chamber (110) formed in the housing (401),
a tumble belt (414) which is arranged in the process chamber (110) and which forms a trough (414), and
a mount (601) to which one or more blasting nozzles (111, 611, 612) are fastened, wherein the mount (601) is arranged to be movable relative to the trough (414).

### Example 14: The Blast Machine (100) According to Example 13, which Furthermore Comprises

an actuator (614) for the mount (601), and
a control logic (160) which is configured to activate the actuator (614) in order to move the mount (601).

### Example 15: The Blast Machine (100) According to Example 14

wherein the control logic is configured to activate the actuator so that it moves the mount transversely to a direction of movement of the tumble belt (414).

### Example 16: The Blast Machine (100) According to any One of Examples 13 to 15

wherein the control logic (160) is configured to activate the actuator (614) so that it moves the mount (601) toward the trough (414) or away from the trough (414).

### Example 17: The Blast Machine (100) According to Example 16, which Furthermore Comprises

a distance sensor that determines a distance between the mount and process components in the trough (414),

wherein the control logic is configured to form a control loop in order to regulate this distance to a setpoint value by moving the mount toward the trough (414) or away from the trough (414)

while the tumble belt (414) is moving.

### Example 18: A Blast Machine (100) which Comprises

a housing (401),
a process chamber (110) formed in the housing (401),
a tumble belt (414) which is arranged in the process chamber (110) and which forms a trough (414), and
a partition wall extending along the direction of movement of the tumble belt (414) and arranged to divide the process chamber (110) into two areas.

### Example 19: A Method for Operating a Blast Machine (100) Having a Process Chamber (110) Having a First Outflow (191) and a Second Outflow (182), Wherein the Method Comprises

alternately opening the first outflow (191) or the second outflow (182) depending on an operating mode,

wherein the operating mode is selected from: unpacking (3001) process components from a powder cake; depowdering (3002) process components; compacting process components.

### Example 20: The Method According to Example 19

wherein the second outflow (182) is connected to a closed blasting material circuit (180),

wherein the first outflow (191) is not connected to the closed blasting material circuit (180).

### Example 21: A Tumble Belt (410) for a Blast Machine (100), Comprising

multiple tumble belt segments (501-506) which can be connected to one another and which have contact features which are configured to engage corresponding contact features of webs (511-513) in order to form a tumble belt having webs (511-513) oriented perpendicularly to the tumble belt surface in this way.

### Example 22: The Tumble Belt (410) According to Example 21

wherein the webs (511-513) are arranged in such a way that they promote a movement of process components (90) arranged in a trough (410) formed by the tumble belt (410) perpendicular to a direction of movement of the tumble belt (410).

### Example 23: A Blast Machine (100) which Comprises

a housing (401),
a process chamber (110) formed in the housing (401),
an ionization bar (671) arranged in the process chamber (110), and
a gas source configured to flush the ionization bar (671) with air or an inert gas.

### Example 24: A Method for Operating a Blast Machine (100), which Comprises a Process Chamber (110)

at least one first fan, and at least one second fan, wherein the at least one first fan (403) is configured to extract substances from the process chamber (110) using a first suction power and a first volume flow, and wherein the at least one second fan (402) is configured to extract the substances out of the process chamber (110) using a second suction power and a second volume flow,

wherein the method comprises:
while the process chamber is being loaded with plastic components, operating the second fan and switching off the first fan,
after the process chamber has been loaded with the plastic components and while the plastic components are being blasted, operating both the first fan and the second fan.

Obviously, the features of the embodiments and aspects of the invention described above can be combined with one another. In particular, the features can be used not only in the combinations described, but also in other combinations or taken on their own, without leaving the area of the invention.

For example, various techniques have been described above, for example in connection with the fan (cf. FIG. 6) for a blast machine with a tumble belt. At least some of the techniques described herein can also be used in connection with blast machines without a tumble belt, for example for a blast machine that has a basket in which the process components can be arranged in the process chamber. For example, the basket could rotate so as to move the process components.

Furthermore, various examples have been described above in connection with a lifting door that can be displaced up and down. As a general rule, other types of doors can be used to close a front-loaded process chamber, such as doors that slide sideways or doors that fold. Doors to be hooked and unhooked could also be used.

For example, techniques were described above in which fan modules, for example the fan modules 402, 403, provide certain functionalities. For example, it was described that the fan module 402 can extract air and dust from the process chamber 110. In general, it would be possible for the fan modules 402, 403 to be variably configurable. For example, the fan of the fan module 402 could optionally be connected to the process chamber 110 by a corresponding opening in the process chamber 110, or to a collection container, for example a waste container (cf. container 201 in FIG. 1). Then a waste container could be sucked empty by operating the fan and all waste products could be collected in a central container.

1. A blast machine for blasting plastic said blast machine comprising:
components that are obtained by a 3D printing method,
a housing,
a front-loaded process chamber formed in said housing,
at least one first fan, which is configured to extract substances from said process chamber using a first suction capacity and a first volume flow, and
at least one second fan, which is configured to extract substances from said process chamber using a second suction capacity and a second volume flow,
a tumble belt, which is arranged in said process chamber and which forms a trough,
wherein said first suction capacity is greater than said second suction capacity,
wherein said first volume flow is less than said second volume flow.

2. The blast machine according to claim 1,
wherein said first fan is designed as a side channel compressor and wherein said second fan is designed as a radial fan.

3. The blast machine according to claim 1,
wherein said first fan is configured to extract blasting material and residues of powder cake from the 3D printing method,
wherein said second fan is configured to extract gas and dust.

4. The blast machine according to claim 1,
wherein said first fan is configured to extract blasting material during the blasting of the plastic components into an outflow of the process chamber and along a blasting material circuit to a blasting material container,
wherein the first fan is furthermore configured to extract powder cake residues from the 3D printing method into the outflow of the process chamber during the blasting of the plastic components,
the blast machine furthermore comprising:
a separating device, which is configured to separate the blasting material from the residues of the powder cake.

5. The blast machine according to claim 1, furthermore comprising:
a fan module, comprising: said second fan, a lattice structure in an opening of the process chamber leading to said second fan, and an exchangeable filter arranged between a surface of the lattice structure facing away from an interior of the process chamber and said second fan of the fan module, which is configured to filter fine dust particles.

6. The blast machine according to claim 1, furthermore comprising:
a lifting door which is arranged in front of said process chamber and which can be moved along a longitudinal direction between a closed position and an open position, wherein a lower edge of said lifting door in the closed position rests on a sealing edge of said housing, so that said process chamber is closed to form a seal, and
a sealing plate having an upper edge and a lower edge, wherein said sealing plate can be detachably arranged such that said lower edge of said sealing plate rests on the sealing edge of said housing and said lower edge of said lifting door rests on said upper edge of said sealing plate when said lifting door is located in an intermediate position between the closed position and the open position such that said process chamber is closed to form a seal,
wherein one or more hand ports are arranged in said sealing plate.

7. The blast machine according to claim 6, which furthermore comprises:
a guide rail arranged in said housing and extending transversely to the longitudinal direction of movement of said lifting door,
wherein said sealing plate is movably arranged in said guide rail.

8. The blast machine according to claim 6,
wherein said sealing edge of said housing is formed on a flap of said housing which can be folded out when said lifting door is not in the closed position,
wherein said flap is arranged in relation to said tumble belt in such a way that process components can slide out of said trough via said flap.

9. The blast machine according to claim 1, furthermore comprising:
a frame assembly for said tumble belt, which has an upper deflection roller and a lower deflection roller and which is configured to guide a movement of said tumble belt.

10. The blast machine according to claim 9,
wherein the frame assembly is arranged to be pivotable between an operating position and a maintenance position about a pivot axis arranged in the area of said upper deflection roller.

11. The blast machine according to claim 10, furthermore comprising:
a locking mechanism for said frame assembly, which is configured to unlock an engagement between said housing and said frame assembly when said frame assembly is arranged in said maintenance position, and
a motor, which is connected to said upper deflection roller via a drive shaft formed by said locking mechanism.

12. The blast machine according to claim 9,
wherein said frame assembly furthermore has guide channels which extend along a direction of movement of said tumble belt in an area facing toward a trough formed by said tumble belt and which are configured to guide said tumble belt when moving.

13. The blast machine according to claim 1, furthermore comprising:
a mount to which one or more blasting nozzles are fastened, wherein said mount is arranged to be movable relative to said trough.

14. The blast machine according to claim 13, furthermore comprising:
an actuator for said mount, and
a control logic which is configured to activate said actuator in order to move said mount.

15. The blast machine according to claim 14,
wherein said control logic is configured to activate said actuator so that it moves said mount transversely to a direction of movement of said tumble belt.

16. The blast machine according to claim 13,
wherein said control logic is configured to activate said actuator so that it moves said mount toward said trough or away from said trough.

17. The blast machine according to claim 16, furthermore comprising:
a distance sensor that determines a distance between said mount and process components in said trough,
wherein said control logic is configured to form a control loop in order to regulate the distance to a setpoint value by moving said mount toward said trough or away from said trough while said tumble belt is moving.

18. The blast machine according to claim 1, furthermore comprising:
a partition wall extending along the direction of movement of said tumble belt and arranged to divide said process chamber into two areas.

19. The blast machine according to claim 1,
wherein said tumble belt comprises a plurality of tumble belt segments which are connected to one another and which have contact features which are configured to engage corresponding contact features of webs in order to form said tumble belt having webs oriented perpendicularly to the tumble belt surface in this way, optionally wherein said webs are arranged in such a way that they promote a movement of process components arranged in a trough formed by said table belt perpendicular to a direction of movement of said tumble belt.

20. (canceled)

21. A method, comprising:
operating a blast machine according to claim 1.
